(19) United States
(12) Patent Application Publication
(10) Pub. No.: US 2018/0122027 A1
(43) Pub. Date: May 3, 2018

(54) CONTRACT ADVISOR

(71) Applicant: International Business Machines Corporation, Armonk, NY (US)

(72) Inventors: Romelia H. Flores, Keller, TX (US); Christian E. Loza, Denton, TX (US); Olivia G. Loza, Denton, TX (US)

(21) Appl. No.: 15/336,908

(22) Filed: Oct. 28, 2016

(51) Int. Cl. G06Q 50/18; G06F 3/0482; G06F 17/24; G06F 17/27; G06F 17/22; G06Q 10/10

(52) U.S. Cl. CPC G06Q 50/188; G06F 3/0482; G06Q 10/10; G06F 17/2705; G06F 17/2264; G06F 17/241

(57) ABSTRACT

A method includes determining a user is presented with a contract and sending the contract to an advisory user, where the advisory user provides feedback for the contract. Responsive to receiving feedback from the advisory user, the method determines a recommendation for an action on whether to accept the contract based on the received feedback from the advisory user and one or more summary points, where the one or more summary points include identified terms and phrases from the contract. The method displays the contract, along with the received feedback from the advisory user, a recommendation for an action on whether to accept the contract, and the summary points.

### BACKGROUND

The present invention relates generally to the field of textual analytics, and more particularly to analyzing contracts utilizing textual analytics.

Data analytics is the process of parsing a set of unstructured data into separate components and converting the set of unstructured data into information, which can be utilized by another machine or program.

Textual analytics relies on the application of statistical, linguistic, and structural techniques to extract and classify information from textual sources. Textual analytics can be further subdivided into a number-based system, where the number-based system can, for example, identify frequency of word usage. Furthermore, textual analytics can be configured to analyze textual and language structures in electronic documents such as, contracts.

Contracts are legally binding agreements that create enforceable obligations. Contracts govern the exchange of goods, services, and software through specifying the terms, conditions, and obligations of each contracting party.

### SUMMARY

Embodiments of the present invention include a method, computer program product, and computer system for analyzing a contract presented to a user. A computer-implemented method includes: responsive to determining a user is presented with a contract, sending, by one or more processors, the contract to an advisory user, wherein the advisory user provides feedback for the contract; responsive to receiving feedback from the advisory user, determining, by one or more processors, a recommendation for an action on whether to accept the contract based in part on the received feedback from the advisory user and one or more summary points, wherein the one or more summary points include one or more identified terms and phrases from the contract; and displaying, by one or more processors, the contract, along with the received feedback from the advisory user, the recommendation on whether to accept the contract, and the one or more summary points.

### BRIEF DESCRIPTION OF THE DRAWINGS

FIG. 1 is a functional block diagram illustrating a distributed data processing environment, in accordance with an embodiment of the present invention.

FIG. 2 is a flowchart depicting operational steps of a contract advisor program for analyzing a contract and providing summary points of the contract, in accordance with the present invention.

FIG. 3 illustrates a screenshot of a contract advisor program analyzing a contract on a client device, in accordance with the present invention.

FIG. 4 is a block diagram of components of a computer system, such as the server computer of FIG. 1, in an embodiment in accordance with the present invention.

### DETAILED DESCRIPTION

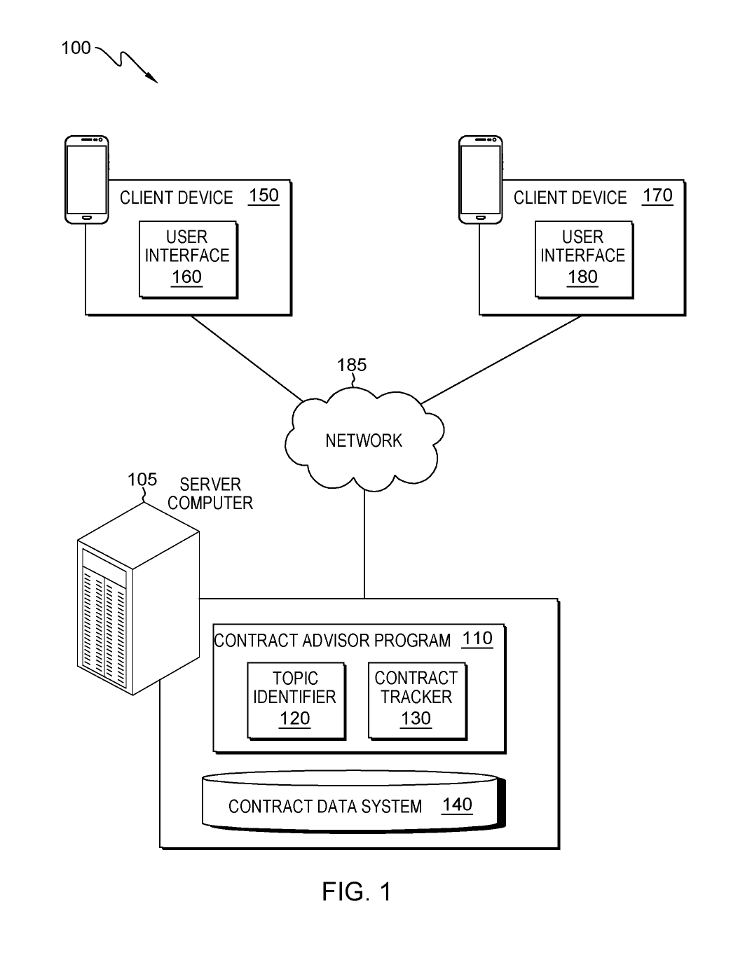

Example embodiments in accordance with the present invention will now be described in detail with reference to the Figures. FIG. 1 is a functional block diagram, illustrating distributed data processing environment 100. Distributed data processing environment 100 includes server computer 105, client device 150, and client device 170, all interconnected over network 185.

Server computer 105 may be a desktop computer, a laptop computer, a tablet computer, a specialized computer server, a smartphone, or any other computer system known in the art. In certain embodiments, server computer 105 represents a computer system utilizing clustered computers and components that act as a single pool of seamless resources when accessed through network 185, as is common in data centers and with cloud computing applications. In general, server computer 105 is representative of any programmable electronic device or combination of programmable electronic devices capable of executing machine readable program instructions and communicating with other computer devices via a network. In one embodiment, server computer 105 includes contract advisor program 110, topic identifier 120, contract tracker 130, and contract data system 140 accessible by client device 150, client device 170, and any other electronic devices not illustrated in FIG. 1, via network 185.

Client device 150 and client device 170 may be a laptop computer, tablet computer, netbook computer, personal computer (PC), personal digital assistant (PDA), smartphone, wearable device (e.g., smart watch, personal fitness device, personal safety device), or any programmable computer system known in the art with an interactive display. In one embodiment, client device 150 is associated with a user that is presented with a contract and client device 170 is associated with an advisory user of the user associated with client device 150. Client device 150 and client device 170 include user interface 160 and user interface 180, respectively. In general, client device 150 and client device 170 are representative of any programmable electronic device or combination of programmable electronic devices capable of executing machine-readable program instructions and communicating with users of other electronic devices via network 185. Client device 150 and client device 170 may also include various programs not illustrated in FIG. 1. The various programs on client device 150 and client device 170 include a web browser, an electronic mail client, security software (e.g., a firewall program, a geo-locating program, an encryption program, etc.), an instant messaging (IM) application (app), and a communication (e.g., phone) application.

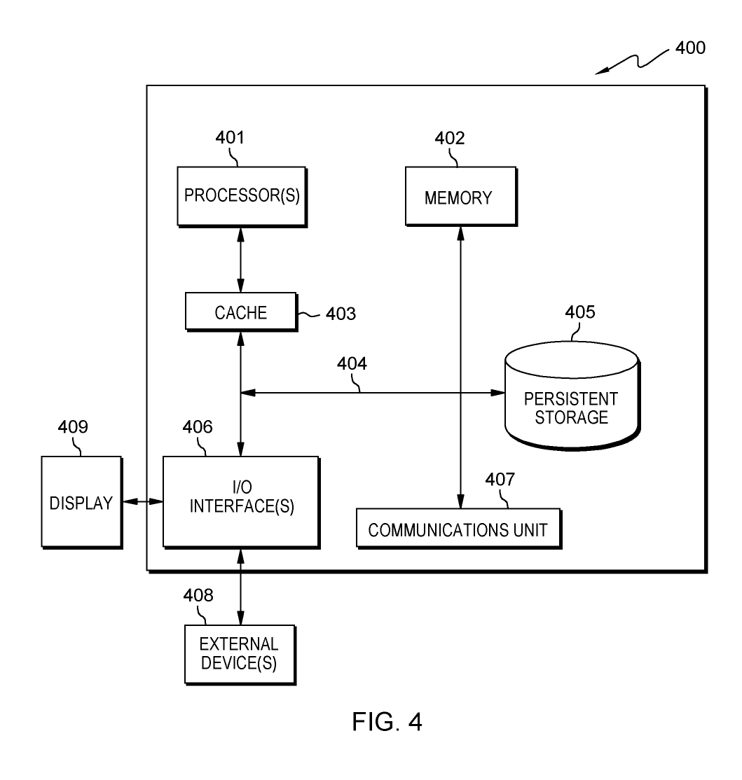

In one embodiment, a user of client device 150 or client device 170 can interact with user interface 160 or user interface 180, respectively, through a touch screen that performs as both an input device to a graphical user interface (GUI) and as an output device (i.e., an electronic display) presenting a plurality of icons associated with software applications or images depicting the executing software application. Optionally, a software application (e.g., a web browser) can generate user interface 160 and user interface 180 operating within the GUI of client device 150 and client device 170. User interface 160 and user interface 180 accept inputs from a plurality of input/output (I/O) devices including, but not limited to, a tactile sensor interface (e.g., a touch screen or a touchpad) referred to as a multi-touch display. An I/O device interfacing with user interface 160 and user interface 180 may be connected to client device 150 and client device 170, respectively, which may operate utilizing wired (e.g., USB port) or wireless network communications (e.g., infrared, NFC, etc.). Client device 150 and client device 170 may include components, as depicted and described in further detail with respect to FIG. 4, in accordance with embodiments of the present invention.

In one embodiment, contract advisor program 110 operates in distributed data processing environment 100, on server computer 105. In another embodiment, contract advisor program 110 operates in a client-side based setting, for example on client device 150 or client device 170. Contract advisor program 110 provides the capability to analyze a contract or service agreement for a user of client device 150 and provide the user of client device 150 with a summary of highlighted aspects of the contract. Contract advisor program 110 can receive user preferences for analyzing contracts, which contract advisor program 110 stores in the form of a user profile for the user of client device 150. Contract advisor program 110 can determine when the user of client device 150 is being presented with a contract and determine the summary points for the contract based on the user preferences. Contract advisor program 110 sends the contract with the determined summary points to a list of advisory users (e.g., user of client device 170) and receives feedback from the advisory users within a pre-determined duration of time. Subsequently, contract advisor program 110 can determine a recommendation for action on client device 150 on whether to accept or reject the contract, and display the recommendation via user interface 160, along with the received feedback from the advisory users.

In one embodiment, contract advisor program 110 provides the capability to scan content presented via user interface 160 to the user of client device 150 and determine whether the content includes a contract or service agreement. In this embodiment, contract advisor program 110 scans a document. Through the functions of topic identifier 120, contract tracker 130, and contract data system 140, contract advisor program 110 utilizes prior advisory user suggestions and analyzes the contract. In addition, contract advisor program 110 incorporates the stored information, from contract data system 140, to provide recommendations for action. In yet another embodiment, contract advisor program 110 includes topic identifier 120 and contract tracker 130. Contract advisor program 110 utilizes topic identifier 120 and contract 130, along with historical contract information stored in contract data system 140 to determine a recommendation for action on client device 150. In one embodiment, contract advisor program 110 provides the capability to preemptively display, via user interface 160, a list of topic specific terms (i.e., identified terms) based on user preferences included in the user profile. In this example, contract advisor program 110 preemptively, without any user input, presents a user with software usage terms to initiate the contract advisor program 110. This is an additional operational pathway for contract advisor program 110. Contract advisor program 110 initiates through presenting terms that have not been entered into the display by the user. The user may select the terms, from a group of terms from different contract genres, presented by contract advisor program 110 to begin analyzing a contract. Upon being presented with a contract, contract advisor program 110 also has the ability to send requests for feedback on a contract via an instant messaging application (IM), an email client, or through communication (e.g., phone) application.

In one embodiment, contract advisor program 110 includes topic identifier 120 and contract tracker 130 as independently operating modules. In an alternative embodiment, contract advisor program 110 performs the operational steps of topic identifier 120 and contract tracker 130. Topic identifier 120 can provide contract advisor program 110 with information of previously analyzed contracts, such as, related contract terms, and identify if specific items exist within a contract that a user of client device 150 is viewing. In the event topic identifier 120 identities specific items within the contract based on the historical data of previously analyzed contracts, contract advisor program 110 determines to include the identified specific items in the summary points for the contract. Contract tracker 130 provides contract advisor program 110 the capability to store a copy of the contracts that the user of client device 150 previously accepted, along with any associated comments received from the advisory user (e.g., user of client device 170) in contract data system 140. Contract tracker 130 also provides contract advisor program 110 the capability to track which comments (i.e., advice) the user of client device 150 has previously received and accepted or rejected from advisory users (e.g., user of client device 170).

Contract data system 140, a database, located on server computer 105, represents any type of storage device capable of storing data that is accessed and utilized by contract advisor program 110. In other embodiments, contract data system 140 represents multiple storage devices within server computer 105. Contract data system 140 stores information such as, but not limited to, account information, credentials for authentication, user preferences, lists of advisory users, previously accepted contracts, previously rejected contracts, industry specific terms of interest, and frequently presented contracts.

In general, network 185 can be any combination of connections and protocols that will support communications among server computer 105, client device 150, and client device 170. Network 185 can include, for example, a local area network (LAN), a wide area network (WAN), such as the Internet, a cellular network, or any combination of the preceding, and can further include wired, wireless, and/or fiber optic connections. In one embodiment, contract advisor program 110 can be a web service accessible via network 185 to a user of client device 150 and client device 170. In another embodiment, contract advisor program 110 may be operated directly by a user of server computer 105.

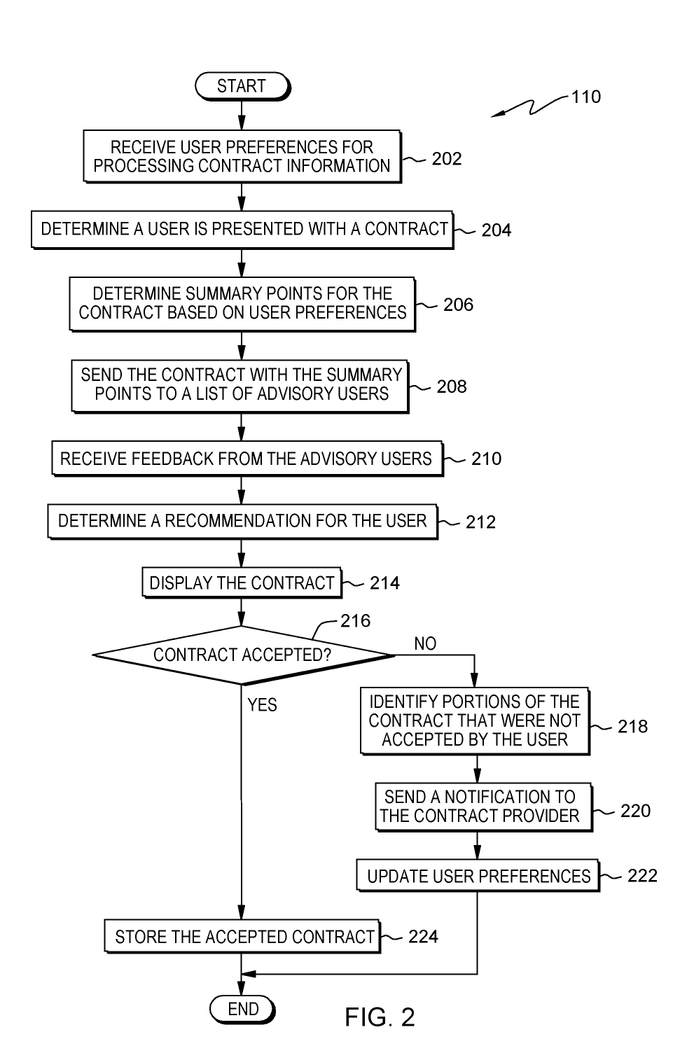

FIG. 2 is a flowchart depicting operational steps of contract advisor program 110 for analyzing a contract and providing summary points of the contract, in accordance with the present invention.

Contract advisor program 110 receives user preferences for processing contract information (202). In one embodiment, contract advisor program 110 receives user preferences, which include, but are not limited to, user defined topics in a contract, a list of advisory users, and types of contracts that contract advisor program 110 maintains in contract data system 140. Contract advisor program 110 can receive a user name (i.e., account information) associated with an account, along with a password (i.e., credentials) associated with an existing user profile. Upon authentication of the credentials for the received account information, contract advisor program 110 can prompt the user to update new preferences on user-defined topics in a contract for which contract advisor program 110 is identifying in a document. Additionally, contract advisor program 110 can prompt the user to specify new advisory users or delete existing advisory users and update what types of contracts and advisory users that contract advisor program 110 maintains in contract data system 140.

Contract advisor program 110 determines a user is presented with a contract (204). In one embodiment, contract advisor program 110 determines a user has access to a webpage, where the webpage presents the user with a contract. Contract advisor program 110, utilizing topic identifier 120, analyzes topics present on the webpage to determine if specific items within the data exist, to indicate the information presented on the webpage is a contract. In another embodiment, contract advisor program 110 is presented with a scanned document. In this example, contract advisor program 110 utilizes topic identifier 120 to analyze the content of the scanned document to determine whether the scanned document is a contract. In yet another embodiment, a user queries contract advisor system 110 to analyze a contract. In this example, a user receives a document from an electronic mail client. Contract advisor system 110 receives a request from the user to analyze the contract. Contract advisor system 110 determines that the user is being presented with a contract based upon the request to analyze the contract.

Contract advisor program 110 determines summary points for the contract based on user preferences (206). In one embodiment, contract advisor program 110 reviews the contract and presents the user with highlighted topics and summary points. For example, contract advisor program 110 analyzes an output contract for a farmer's inventory. Contract advisor program 110 identifies key terms and phrases within the output contract, based on the received user preferences, which include a list of identified terms, for processing contract information. Based on the identified key terms and phrases, contract advisor program 110 determines an absence of a particular clause in the output contract due to contract advisor program 110 not being able to identify the presence of key terms and phrases. Based upon the lack of language suggesting the presence of the particular clause, contract advisor program 110 creates a summary point, where the summary point states that a particular clause is missing from the output contract.

In one embodiment, contract advisor program 110 analyzes and summarizes key points of an online movie ticket purchase. For example, based upon user preferences, contract advisor program 110 may determine key points of interest, and summarizes the limiting items found within sections of the particular contract. For example, contract advisor program 110 presents the user with a summary of key items (sections of the overall contract) found. Contract advisor program 110 highlights the area of focus in red with links to additional information regarding the items. In addition, contract advisor program 110 presents the user with an advisory user link. The advisory user link queries contract advisor program 110 to show a list of advisory users who can be contacted, according to user preference, to inquire about a particular term or contract flag. Furthermore, contract advisor program 110 can learn advisory users, or groups of advisory users, particular to a type of contract and present a link to contact these advisory users. Contract advisor program 110 can also provide an override link so the user may update advisory user preferences for future contracts.

Contract advisor program 110 sends the contract, with the summary points, to a list of advisory users (208). In one embodiment, contract advisor program 110 automatically sends a Short Message Service (SMS) text message to a list of select advisory users. In this example, contract advisor program 110 sends a notification to the advisory users to inquire about a particular term or flagged language in the contract presented to the user. In another embodiment, contract advisor program 110 presents the user viewing the contract with an advisory user link to see a list of advisory users to message about the highlighted aspects of the contract. For example, contract advisor program 110 generates a hyperlink on the webpage, via the user interface, for the user to initiate communication and solicit feedback from or simply notify the advisory users concerning the highlighted aspects of the contract. In addition, contract advisor program 110 may present, via the user interface, hyperlinks of each summary point related to the contract. A user viewing the contract may select the hyperlink, and query contract advisor program 110 to automatically include the particular summary point to the advisory user to solicit immediate feedback on the summary point or to notify the advisory users of specific contact summary points from the advisory user.

In another embodiment, contract advisor program 110 receives a query from a user to send an email to an advisory user requesting that the advisory user reviews the contract. In this example, contract advisor program 110 analyzes a contract. Contract advisor program 110 presents the user with the option to solicit feedback from an advisory user, via email, to review the contract in its entirety, or to review the summary points of the contract. Contract advisor program 110 has the ability to identify a list of advisory users that can provide feedback on a contract based on a correlation between a type of contract presented to the user and contracts for which an advisory user from the list of advisory users previously provided feedback. The user queries contract advisor program 110 to send the email to the advisory user requesting the advisory user review the contract in its entirety. Contract advisor program 110 presents the advisory user the option to show the contract with or without the analysis performed by contract advisor program 110.

Contract advisor program 110 receives feedback from the advisory users (210). In this embodiment, contract advisor program 110 obtains feedback on the highlighted summary points that the list of advisory users made on particular topics within the contract. In this example, contract advisor program 110 allows the user to review the advisory user feedback and allows the user viewing the contract to request additional assistance or clarification from the list of advisory users. Contract advisor program 110, via client device 170, allows the advisory users to review contracts and to review any information (or summary points) requested by a user, in real time. In one embodiment, contract advisor program 110 may display one advisory user, multiple advisory users, a group of advisory users, or multiple groups of advisory users. In an example, contract advisor program 110 receives feedback, on the presented contract, from multiple advisory users, and groups of advisory users. Contract advisor program 110 incorporates the feedback, parses the feedback in a manner to differentiate the feedback from each advisory user and user group. Contract advisor program 110 then matches each comment to the particular advisory user, including the advisory user groups, and sends the feedback from the advisory users to the user in a presentation that allows the user to be able to match particular comments to the particular advisory user or advisory user group.

Contract advisor program 110 determines a recommendation for the user (212). In one embodiment, contract advisor program 110 determines a recommendation, or course of action, based upon previous transactions/events associated with the same, or similar, contract, advisory user feedback, user preferences, and the corpus of data stored in contract data system 140. In this example, contract advisor program 110 compiles this information and utilizing pre-loaded configurations, determines whether the user should accept the contract or reject the contract. In another embodiment, contract advisor program 110, determines a recommendation for the user without any feedback from an advisory user. In this example, contract advisor program 110 recognizes the user as being the advisory user. Contract advisor program 110 does not incorporate input or suggestions from outside sources. The user's preferences, in combination with the trained corpus of contractual data in contract advisor program 110, are used to determine a recommendation for the user.

Contract advisor program 110 displays the contract (214). In this embodiment, contract advisor program 110 displays, via the user interface, whether the user should accept or reject the contract. Contract advisor program 110 also presents why contract advisor program 110 believes the user should accept or reject the program. In an example, contract advisor program 110 accesses a database of other output contracts related to farming and determines which of the other output contracts lacked the particular clause. Contract advisor program 110 determines that the lack of the particular contractual clause resulted in excess legal cost and lost revenue. Subsequently, contract advisor program 110 may access a case law or legal database, and display the contract along with the related case law items. Contract advisor program 110 may include a recommendation for the user to include the particular clause prior to accepting the contract.

Contract advisor program 110 determines whether the user has accepted the contract (216). In the event contract advisor program 110 determines the user has not accepted the contract (“no” branch, 216), contract advisor program 110 identifies (218) portions of the contract that were not accepted by the user. In the event contract advisor program 110 determines the user has accepted the contract (“yes” branch, 216), contract advisor program 110 stores (224) the accepted contract.

Contract advisor program 110 identifies portions of the contract that were not accepted by the user (218). In this example, contract advisor program 110 uses topic identifier 120 to highlight relevant portions of the contract that the user cited as probative, and contract data system 140, to store the information, to supplement the existing corpus or information related to user preferences, advisory user preferences, particular language in the contract, and to track the history of advice the user has accepted or rejected. In one embodiment, contract advisor program 110 displays the contract that was not accepted. Contract advisor program 110 queries the user to select the portion of the contract that were not accepted. Contract advisor program 110 receives the highlighted contract from the user and consolidates the highlighted information of the contract.

Contract advisor program 110 sends a notification to the contract provider (220). In one embodiment, contract advisor program 110 sends a notification that the user has rejected the contract. In an example, contract advisor program 110 is sending notification to a user that also is utilizing contract advisor program 110. In this example, contract advisor program 110 sends an accompanying rationale, citing the highlighted summary points that the user did not accept, to the contract provider. Contract advisor program 110 presents the contract provider that is also utilizing contract advisor program 110 with an option to amend the contract such that the objected terms are stricken from the contract. In this example, contract advisor program 110 can also present the provider, also operating contract advisor program 110, with the option to present a new contract or negotiate with the user. In another embodiment, contract advisor program 110 sends notification of the rejection to the contract provider. In this example, contract advisor program 110 is sending an alert that informs the provider that the user has not accepted the contract.

Contract advisor program 110 updates user preferences (222). In one embodiment contract advisor program 110 utilizes analysis specific to the presented contract to update the user preferences. In this embodiment, contract advisor program 110 combines the summary points of the contract, the portions of the contract the user has not accepted, and the feedback received from the advisory users to update the user preferences. For example, contract advisor program 110 has the ability to update user preferences, where future contracts presented to the user can include summary points identifying portions of the contract the user has not accepted in previous contracts.

Contract advisor program 110 stores the accepted contract. (224). In this embodiment, contract advisor program 110 receives indication that a user has accepted the contract. In this example, contract advisor program 110 stores the contract the user has accepted at a storage location (e.g., contract data system 140). Additionally, contract advisor program 110 has the ability to store the summary points of the contract, feedback from advisory users, and any provided updates to the user preferences in contract data system 140.

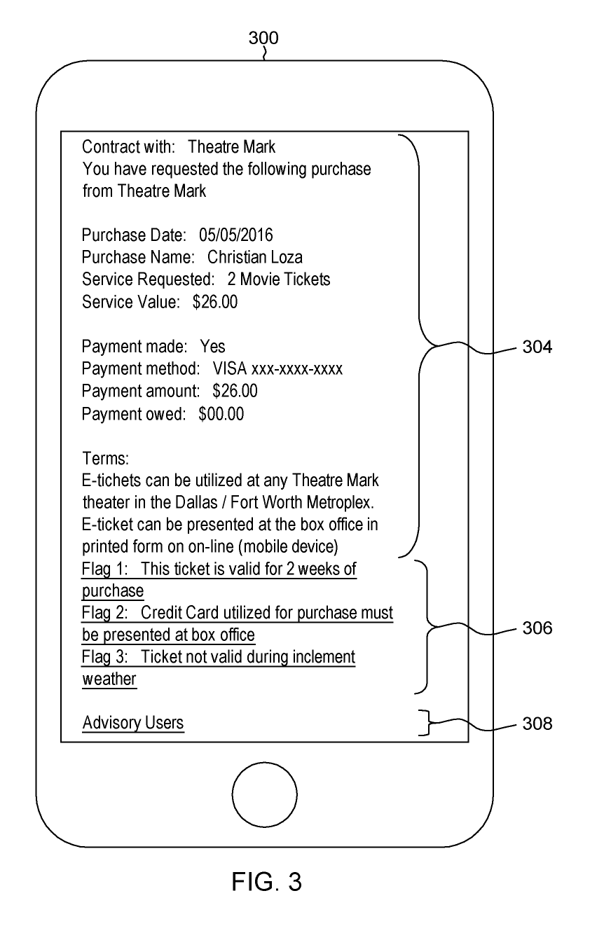

FIG. 3 illustrates a screenshot of contract advisor program 110 operating on computing device 300 (e.g., a smartphone), analyzing a contract on computing device 300, in accordance with the present invention. In an example embodiment, computing device 300 is a programmable computer system, known in the art, including an interactive display, capable of communicating with server computer 105, executing contract advisor program 110 and communicating with users of other electronic devices via network 185. For example, contract advisor program 110 presents contract 304 and summary points 306 for contract 304 to a user, via computing device 300. Contract 304 represents a contract for purchasing movie tickets online for “Theatre Mark” where contract 304 includes purchaser information, a date of purchase, items purchased, an overall value for the items purchased, and terms of agreement for the items purchased. Contract advisor program 110 determines summary points 306 for contract 304 based on the user preferences for the user viewing contract 304. Summary points 306 includes multiple flags for contract 304, where contract advisor program 110 allows for the user to contact a specific party concerning each of the flags. Contract advisor program 110 also provides advisory user link 308 to allow the user of computing device 300 to contact the advisory users (i.e., advisory users) to receive feedback pertaining to contract 304.

In one embodiment, “Flag 1” in summary points 306 specifics that the tickets are valid for 2 weeks from the date of purchase. Smartphone 300 allows for the user to select individuals to send an alert to regarding “Flag 1” in summary points 306. Contract advisor program 110 can receive a selection to send an SMS message to the purchaser and any other users the purchaser specifies. In this embodiment, “Flag 2” in summary points 306 specifies the contract terms stating that the credit card utilized for purchase must be presented at the box office. Contract advisor program 110 can learn which users are to be alerted regarding contractual terms of interest. Contract advisor program 110 learns the users based on the input provided by the user over time. In yet another embodiment, “Flag 3” in summary points 306 specifies, an additional contractual term, that the purchased ticket is not valid during inclement weather. Contract advisor program 110 can learn, based on the history of user input, which users are to be alerted with respect to the contractual terms of interest. Contract advisor program 110 can also learn time duration of the contract term, and access a weather database via the internet to alert the user of impending inclement weather.

FIG. 4 depicts computer system 400, where computer system 400 represents a computer system in distributed data processing environment 100. Server computer 105 represents an example of a computer system in distributed data processing environment 100, where server computer 105 includes contract advisor program 110. Computer system 400 includes processors 401, cache 403, memory 402, persistent storage 405, communications unit 407, input/output (I/O) interface(s) 406 and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processors 401 by holding recently accessed data, and data near recently accessed data, from memory 402.

Program instructions and data used to practice embodiments of the present invention may be stored in persistent storage 405 and in memory 402 for execution by one or more of the respective processors 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface 406 may provide a connection to external devices 408 such as a keyboard, keypad, a touch screen, and/or some other suitable input device. External devices 408 can also include portable computer readable storage media such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method comprising:
responsive to determining a user is presented with a contract, identifying, by one or more processors, user preferences for processing contracts;
determining, by one or more processors, one or more summary points for the contract based on the user preferences;
wherein the one or more summary points include one or more identified terms and phrases from the contract, and wherein the user preferences include a list of identified terms and phrases to include in the one or more summary points;
determining, by one or more processors, a recommendation indicating whether the user should accept the contract, based in part on feedback provided by one or more advisory users and one or more summary points; and
initiating, by one or more processors, display of the contract, along with the feedback provided by one or more advisory users, the determined recommendation indicating whether the user should accept the contract, and the one or more summary points.

2. The method of claim 1, further comprising:
sending, by one or more processors, the contract to the one or more advisory users for feedback; and
receiving, by one or more processors, feedback on the contract from the one or more advisory users.

3. The method of claim 1, further comprising:
responsive to determining the user accepts the contract, storing, by one or more processors, an accepted contract, the received feedback from the advisory user, and the one or more summary points at a storage location.

4. The method of claim 1, further comprising:
responsive to determining the user does not accept the contract, identifying, by one or more processors, a portion of the contract that the user does not accept; and
sending, by one or more processors, a notification to a contract provider of the contract, wherein the notification includes an identified portion of the contract that the user does not accept.

5. The method of claim 2, further comprising:
updating, by one or more processors, the user preferences based on the one or more summary points, the received feedback from the advisory user, and an identified portion of the contract that the user does not accept.

6. The method of claim 1, further comprising:
responsive to displaying a recommendation to not accept the contract, identifying, by one or more processors, a portion not included in the contract presented to the user; and
initiating, by one or more processors, display of the identified portion not included in the contract presented to the user.

7. The method of claim 1, further comprising:
displaying, by one or more processors, a list of two or more advisory users to the user presented with the contract, wherein the list of the two or more advisory users correlates to a type of contract; and
responsive to receiving a selection of the advisory user from the list of two or more advisory users from the user, determining, by one or more processors, to send the contract to the advisory user.

8. A computer program product comprising:
one or more computer readable storage media and program instructions stored on at least one of the one or more storage media, the program instructions comprising:
responsive to determining a user is presented with a contract, program instructions to identify user preferences for processing contracts;
program instructions to determine one or more summary points for the contract based on the user preferences;
wherein the one or more summary points include one or more identified terms and phrases from the contract and at least one flagged term that is included in the contract, and wherein the user preferences include a list of identified terms and phrases to include in the one or more summary points;
program instructions to determine a recommendation indicating whether the user should accept the contract, based in part on feedback provided by one or more advisory users and one or more summary points; and
program instructions to initiate display of the contract, along with the feedback provided by one or more advisory users, the determined recommendation indicating whether the user should accept the contract, and the one or more summary points, including the at least one flagged term.

9. The computer program product of claim 8, further comprising program instructions, stored on the one or more computer readable storage media, which when executed by a processor, cause the processor to:
send the contract to the one or more advisory users for feedback; and
receive feedback on the contract from the one or more advisory users.

10. The computer program product of claim 8, further comprising program instructions, stored on the one or more computer readable storage media, which when executed by a processor, cause the processor to:
responsive to determining the user accepts the contract, store an accepted contract, the received feedback from the advisory user, and the one or more summary points at a storage location.

11. The computer program product of claim 8, further comprising program instructions, stored on the one or more computer readable storage media, which when executed by a processor, cause the processor to:
responsive to determining the user does not accept the contract, identify a portion of the contract that the user does not accept; and
send a notification to a contract provider of the contract, wherein the notification includes an identified portion of the contract that the user does not accept.

12. (canceled)

13. The computer program product of claim 8, further comprising program instructions, stored on the one or more computer readable storage media, which when executed by a processor, cause the processor to:
responsive to displaying a recommendation to not accept the contract, identify a portion not included in the contract presented to the user; and
initiate display of the identified portion not included in the contract presented to the user.

14. The computer program product of claim 8, further comprising program instructions, stored on the one or more computer readable storage media, which when executed by a processor, cause the processor to:
display a list of two or more advisory users to the user presented with the contract, wherein the list of the two or more advisory users correlates to a type of contract; and
responsive to receiving a selection of the advisory user from the list of two or more advisory users from the user, determine to send the contract to the advisory user.

15. A computer system comprising:
one or more computer processors;
one or more computer readable storage media; and
program instructions stored on the computer readable storage media for execution by at least one of the one or more computer processors, the program instructions comprising:
responsive to determining a user is presented with a contract, program instructions to identify user preferences for processing contracts;
program instructions to determine one or more summary points for the contract based on the user preferences;
wherein the one or more summary points include one or more identified terms and phrases from the contract and at least one flagged term that is included in the contract, and wherein the user preferences include a list of identified terms and phrases to include in the one or more summary points;
program instructions to determine a recommendation indicating whether the user should accept the contract, based in part on feedback provided by one or more advisory users and one or more summary points; and
program instructions to initiate display of the contract, along with the feedback provided by one or more advisory users, the determined recommendation indicating whether the user should accept the contract, and the one or more summary points, including the at least one flagged term.

16. The computer system of claim 15, further comprising program instructions, stored on the one or more computer readable storage media, which when executed by a processor, cause the processor to:
send the contract to the one or more advisory users for feedback; and
receive feedback on the contract from the one or more advisory users.

17. The computer system of claim 15, further comprising program instructions, stored on the one or more computer readable storage media, which when executed by a processor, cause the processor to:
responsive to determining the user accepts the contract, store an accepted contract, the received feedback from the advisory user, and the one or more summary points at a storage location.

18. The computer system of claim 15, further comprising program instructions, stored on the one or more computer readable storage media, which when executed by a processor, cause the processor to:
responsive to determining the user does not accept the contract, identify a portion of the contract that the user does not accept; and
send a notification to a contract provider of the contract, wherein the notification includes an identified portion of the contract that the user does not accept.

19. The computer system of claim 16, further comprising program instructions, stored on the one or more computer readable storage media, which when executed by a processor, cause the processor to:
update the user preferences based on the one or more summary points, the received feedback from the advisory user, and an identified portion of the contract that the user does not accept.

20. The computer system of claim 15, further comprising program instructions, stored on the one or more computer readable storage media, which when executed by a processor, cause the processor to:
responsive to displaying a recommendation to not accept the contract, identify a portion not included in the contract presented to the user; and
initiate display of the identified portion not included in the contract presented to the user.

21. The method of claim 1, wherein determining one or more summary points for the contract based on the user preferences and feedback provided by the one or more advisory users, comprises:
determining, by one or more processors, the one or more summary points for the contract based on the user preferences;
providing, by one or more processors, the determined one or more summary points and the contract to the one or more advisory users, wherein the one or more advisory users are users that are correlated to a type of contract, the type of contract corresponding to the contract presented to the user; and
receiving, by one or more processors, feedback from the one or more advisory users on the determined one or more summary points and the contract.
